(19) United States
(12) Patent Application Publication
(10) Pub. No.: US 2023/0231140 A1
(43) Pub. Date: Jul. 20, 2023

(54) BINDER COMPOSITION FOR ALL-SOLID-STATE BATTERY, SLURRY COMPOSITION COMPRISING THE SAME AND ALL-SOLID-STATE BATTERY

(71) Applicant: KOREA KUMHO PETROCHEMICAL CO., LTD., Seoul (KR)

(72) Inventors: Han Baek LEE, Seoul (KR); Hoo-Chae KIM, Seoul (KR); June PARK, Seoul (KR); Seung Hyun DO, Seoul (KR); Bona CHOI, Seoul (KR)

(73) Assignee: KOREA KUMHO PETROCHEMICAL CO., LTD., Seoul (KR)

(21) Appl. No.: 18/155,383

(22) Filed: Jan. 17, 2023

(30) Foreign Application Priority Data
Jan. 17, 2022 (KR) 10-2022-0006520

(51) Int. Cl. H01M 4/62

(52) U.S. Cl. CPC H01M 4/622

(57) ABSTRACT

Disclosed is a binder composition for an all-solid-state battery including a conjugated diene-based rubber polymer and a solvent, wherein a content of a cis bond in the conjugated diene-based rubber polymer is 90% by weight or more.

### CROSS-REFERENCE TO RELATED APPLICATION

This application claims priority to and the benefit of Korean Patent Application No. 10-2022-0006520, filed on Jan. 17, 2022, the disclosure of which is incorporated herein by reference in its entirety.

### BACKGROUND

### 1. Field

The present disclosure relates to a binder composition for an all-solid-state battery, a manufacturing method thereof, and a slurry composition including the same.

### 2. Discussion of Related Art

Secondary batteries capable of charging and discharging are used not only in small electronic devices such as mobile phones and laptop computers, but also in large vehicles such as hybrid vehicles and electric vehicles. Accordingly, development of secondary batteries having higher stability and energy density is actively progressing.

An existing lithium ion battery is composed of a carbon-based negative electrode, an electrolyte containing an organic solvent, and a lithium oxide positive electrode, wherein lithium ions are released from the positive electrode and move to the carbon-based negative electrode through the electrolyte during charging by using chemical reactions occurring at the positive electrode and the negative electrode, and discharging proceeds in reverse to the charging process. However, since a lithium ion battery is composed of a cell based on a liquid electrolyte containing an organic solvent, a highly volatile organic solvent may leak due to impact, and the like, and as the energy density is improved, it is highly likely that these battery stability problems will occur.

In order to solve this problem, research and development on an all-solid-state battery including a solid electrolyte to replace a liquid electrolyte is being conducted. However, since components of the all-solid-state battery are solid, securing technology for controlling interfacial resistance between particles is an important matter in terms of improving battery performance, and securing a scalable battery manufacturing process is urgently needed. A solid electrolyte can be divided into sulfides, oxides, and polymers, and among them, sulfide-based solid electrolytes have excellent ionic conductivity and mechanical properties, and thus, research thereon is being most actively conducted. However, since the sulfide-based solid electrolyte has high water reactivity, there is a problem in that hydrogen sulfide, a harmful gas, is generated, so that there is a problem in securing battery stability.

Meanwhile, the all-solid-state battery includes a positive electrode, a negative electrode, and a solid electrolyte, and for example, may be manufactured by interposing a solid electrolyte layer between the positive electrode and the negative electrode. In order to form the solid electrolyte layer with high uniform stability during manufacture of the all-solid-state battery, a solution-type wet process is required. Therefore, the importance of a binder capable of binding each component of such a battery is more emphasized in manufacturing the all-solid-state battery. This is also because the binder needs to serve to stably provide a repeatable movement path for lithium ions for a long period of time by being added to the solid electrolyte layer or an electrode and mutually binding components such as solid electrolyte particles or electrode active materials.

As a binder for existing lithium ion batteries, polyvinylidene fluoride (PVDF) or styrene-butadiene rubber/carboxymethyl cellulose (SBR/CMC) mixtures were used. On the other hand, as a binder for an all-solid-state battery, rubber-based binders are preferred, and among them, acrylonitrile butadiene rubber (NBR) is widely used.

However, the acrylonitrile butadiene rubber has a problem in that electrode adhesive strength is somewhat insufficient. When the electrode adhesive strength is lowered, the formation of a balanced transfer path of ions and electrons in the electrode may be hindered, and an initial charge/discharge efficiency of the electrode may be reduced, resulting in deterioration in battery performance. In addition, the acrylonitrile butadiene rubber has a limitation in selecting a solvent due to a solubility problem, and this organic solvent reacts with the solid electrolyte to cause a problem in that stability is lowered.

Accordingly, it is intended to provide a binder composition suitable for the all-solid-state battery by applying a butadiene-based rubber having excellent adhesive properties as the binder and easy selection of a solvent.

### SUMMARY

The present disclosure is directed to providing a binder composition having excellent solubility in various solvents and excellent electrode adhesive strength, a manufacturing method thereof, and a slurry composition including the same.

According to one aspect, the present disclosure provides a binder composition for an all-solid-state battery including a conjugated diene-based rubber polymer and a solvent, wherein a content of a cis bond in the conjugated diene-based rubber polymer is 90% by weight or more.

In one embodiment, the conjugated diene-based rubber polymer may be a polymer of at least one monomer selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo 1,3-hexadiene.

In one embodiment, a cis content of the conjugated diene-based rubber polymer may be 95% by weight or more.

In one embodiment, the conjugated diene-based rubber polymer may be produced using a neodymium-based catalyst or a nickel-based catalyst.

In one embodiment, the neodymium-based catalyst may include a neodymium salt compound, a conjugated diene-based monomer, an organoaluminum chloride compound, and one or more organoaluminum compounds.

In one embodiment, the nickel-based catalyst may include a nickel salt compound, a conjugated diene-based monomer, an aluminum compound, and a boron fluoride complex compound.

In one embodiment, a weight average molecular weight of the conjugated diene-based rubber polymer may be 100,000 to 2,000,000.

In one embodiment, the conjugated diene-based rubber polymer may have a solution viscosity of 80 to 1,200 cps at 25° C.

In one embodiment, the conjugated diene-based rubber polymer may have a Mooney viscosity of 30 to 100.

In one embodiment, the conjugated diene-based rubber polymer may have a branching degree of 0.8 to 4.0.

In one embodiment, the solvent may be at least one selected from the group consisting of benzene, toluene, xylene, hexane, cyclohexane, methylcyclohexane, ethylcyclohexane, nonane, decane, decalin, tetralin, dodecane, dibromomethane, dichloromethane, chloroform, butyl butyrate, and hexyl butyrate.

In one embodiment, a content of the conjugated diene-based rubber polymer may be 0.5 to 40% by weight based on the total weight of the binder composition.

In one embodiment, the conjugated diene-based rubber polymer may be dissolved in a butyl butyrate solvent at room temperature.

According to another aspect, the present disclosure provides a slurry composition for an all-solid-state battery including: the above-described binder composition; and at least one selected from the group consisting of a conductive material, a positive electrode active material, a negative electrode active material, and a solid electrolyte.

According to still another aspect, the present disclosure provides an all-solid-state battery including: a positive electrode; a negative electrode; and a solid electrolyte, wherein at least one of the positive electrode, the negative electrode, and the solid electrolyte is prepared by applying the slurry composition including the binder composition described above and drying the solvent.

### DETAILED DESCRIPTION OF EXEMPLARY EMBODIMENTS

Hereinafter, one aspect of the present specification will be described. However, the description of the present specification may be implemented in several different forms, and thus is not limited to the embodiments described herein. In order to clearly illustrate the present disclosure, parts irrelevant to the description are omitted.

Throughout the specification, when a part is “connected” to another part, this includes not only the case where it is “directly connected” but also the case where it is “indirectly connected” with another member interposed therebetween. In addition, when a part is said to “include” a component, this means that other components may be further included, not excluded, unless specifically stated to the contrary.

When a range of numerical values is recited herein, the values have the precision of the significant figures provided in accordance with the standard rules in chemistry for significant figures, unless the specific range is otherwise stated. For example, 10 includes the range of 5.0 to 14.9, and the number 10.0 includes the range of 9.50 to 10.49.

Binder Composition for all-Solid-State Battery

A binder for an all-solid-state battery may play a role of mechanically stabilizing components such as an active material and a solid electrolyte inside the battery by interconnecting the components.

The binder composition according to one aspect includes a conjugated diene-based rubber polymer and a solvent, wherein a content of a cis bond in the conjugated diene-based rubber polymer may be 90% by weight or more.

The conjugated diene-based rubber polymer may be a polymer derived from a conjugated diene-based monomer, and the conjugated diene-based monomer may be at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo 1,3-hexadiene.

In the present specification, the cis bond may mean a bond in the same direction as a structure connected to both ends of a double bond portion in a main chain among unit structures derived from the conjugated diene-based monomer in the conjugated diene-based rubber polymer. For example, in a unit structure of polybutadiene, a bond in which carbons 1 and 4 are located in the same direction with 2-3 double bonds interposed therebetween may be a 1,4-cis bond.

The content of the cis bond of the conjugated diene-based rubber polymer may be 90% by weight or more, for example, 90% by weight, 91% by weight, 92% by weight, 93% by weight, 94% by weight, 95% by weight, 96% by weight, 97% by weight, 98% by weight, 99% by weight, 99.9% by weight, or a range between two of these values. When the cis content of the conjugated diene-based rubber polymer is less than 90% by weight, adhesive performance may be deteriorated, and thus the electrode adhesive strength of the binder composition may be deteriorated.

The conjugated diene-based rubber polymer may be produced using a neodymium-based catalyst or a nickel-based catalyst. The conjugated diene-based rubber polymer may have different properties, such as a microstructure, depending on the type of catalyst used in the preparation. The catalyst used in the preparation of the conjugated diene-based rubber polymer may be identified from the properties of the conjugated diene-based rubber polymer or from a trace amount of remaining metal components. For example, a metal component of the catalyst may be confirmed using an inductively coupled plasma (ICP) emission spectrometer or the like. The metal component may be present in a trace amount of less than 100 ppm, less than 50 ppm, less than 30 ppm, or less than 10 ppm.

The neodymium-based catalyst may include a neodymium salt compound, a conjugated diene-based monomer, an organoaluminum chloride compound, and one or more organoaluminum compounds. The neodymium-based catalyst may be a catalyst system in which the neodymium salt compound, the conjugated diene-based monomer, the organoaluminum chloride compound, and the one or more organoaluminum compounds are each mixed in a predetermined molar ratio, for example, 1:5 to 30:1 to 5:10 to 60, and aged under certain conditions.

A weight average molecular weight of the conjugated diene-based rubber polymer may be 100,000 to 2,000,000, for example, 100,000, 200,000, 300,000, 400,000, 500,000, 600,000, 700,000, 800,000, 900,000, 1,000,000, 1,100,000, 1,200,000, 1,300,000, 1,400,000, 1,500,000, 1,600,000, 1,700,000, 1,800,000, 1,900,000, 2,000,000, or a range between two of these values. When the weight average molecular weight of the conjugated diene-based rubber polymer is outside the above range, the processability, adhesive strength, or battery performance of the binder composition may be deteriorated.

A molecular weight distribution of the rubber polymer may be 2.0 to 4.5. For example, a molecular weight distribution of the rubber mixture may be 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, or a range between two of these values. The molecular weight distribution is a value obtained by dividing a weight average molecular weight (Mw) by a number average molecular weight (Mn). The binder composition using a conjugated diene-based rubber polymer having a molecular weight distribution value satisfying the above range may have an excellent balance between adhesion and ease of application.

A solution viscosity at 25° C. of the conjugated diene rubber polymer may be 80 to 1,200 cps, for example, 80 cps, 90 cps, 100 cps, 125 cps, 150 cps, 175 cps, 200 cps, 225 cps, 250 cps, 275 cps, 300 cps, 325 cps, 350 cps, 375 cps, 400 cps, 425 cps, 450 cps, 475 cps, 500 cps 500 cps, 550 cps, 600 cps, 650 cps, 700 cps, 750 cps, 800 cps, 850 cps, 900 cps, 950 cps, 1,000 cps, 1,050 cps, 1,100 cps, 1,150 cps, 1,200 cps, or a range between two of these values. When the solution viscosity satisfies the above range, application of a slurry containing the binder composition is easy, and the adhesive property required as a binder can be satisfied.

A Mooney viscosity of the conjugated diene-based rubber polymer may be 30 to 100, for example, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a range between two of these values. When the Mooney viscosity of the conjugated diene-based rubber polymer falls within the above range, the properties required as a binder composition can be more easily satisfied.

A branching degree of the conjugated diene-based rubber polymer may be 0.8 to 4.0, for example, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, or a range between two of these values. When the branching degree of the conjugated diene-based rubber polymer falls within the above range, it can be dissolved in more various solvents while maintaining the properties required as a binder composition.

An electrode of a secondary battery may be manufactured by forming an active material layer including an active material and a conductive material on a current collector. Since stability and capacity of the battery may be deteriorated when a gap between the conductive material and the active material increases due to a change in volume of the active material during charging and discharging of the secondary battery, this needs to be prevented by bonding through the binder. The electrode may be manufactured by applying a slurry containing the active material, the conductive material, and the binder on a surface of the current collector and drying the solvent.

A solid electrolyte, which is the core of an all-solid-state battery, has a problem of reacting with a polar solvent. Therefore, a binder used as a binder of the solid electrolyte or a binder of the electrode needs to be dissolved in a solvent that has no reactivity with the solid electrolyte or has extremely low reactivity.

The solvent may be at least one selected from the group consisting of benzene, toluene, xylene, hexane, cyclohexane, methylcyclohexane, ethylcyclohexane, nonane, decane, decalin, tetralin, dodecane, dibromomethane, dichloromethane, chloroform, butyl butyrate, and hexyl butyrate. When such a solvent is applied, a reaction with the solid electrolyte is inhibited, so that manufacture of the all-solid-state battery can be facilitated. In addition, the above-described conjugated diene-based rubber polymer may have excellent solubility in the solvent.

The solvent has a boiling point at 1 atm of 80° C. or more, for example, 80° C. or more, 85° C. or more, 90° C. or more, 95° C. or more, 100° C. or more, 100° C. or more, 120° C. or more, 150° C. or more, 170° C. or more, or 200° C. or more, but is not limited thereto.

In the binder composition, the conjugated diene-based rubber polymer may be easily dissolved in a solvent, and thus the binder composition may have excellent processability and electrode adhesive strength. As a result, performance such as long-term stability and battery capacity of the all-solid-state battery can be improved.

A content of the conjugated diene-based rubber polymer may be 0.5 to 40% by weight based on the total weight of the binder composition. In other words, a weight ratio of the conjugated diene-based rubber polymer and the solvent in the binder composition may be 0.5 to 40:60 to 99.5. A proportion of the conjugated diene-based rubber polymer may be, for example, 0.5, 1, 2, 3, 4, 5, 6, 7, 8, 9, 10, 15, 20, 25, 30, 35, 40, or a range between two of these values. A proportion of the solvent may be, for example, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5 or a range between two of these values. When the weight ratio is outside the above range, dissolution of the conjugated diene-based rubber polymer may be difficult, or performance as a binder may be difficult to implement.

The conjugated diene-based rubber polymer may be dissolved in a butyl butyrate solvent at room temperature. For example, when the conjugated diene rubber polymer and the butyl butyrate are mixed at a weight ratio of 5:95, 50% by weight or more, 60% by weight or more, 70% by weight or more, 80% by weight or more, or 90% by weight or more of the mixed conjugated diene-based rubber polymer may be dissolved in the butyl butyrate. When the conjugated diene-based rubber polymer is used, various solvents can be selected and utilized when applied as a binder.

Method of Preparing Binder Composition for all-Solid-State Battery

A method for preparing a binder composition according to another aspect may include: (a) preparing a conjugated diene-based rubber polymer by reacting a conjugated diene-based monomer in the presence of a catalyst; and (b) preparing a binder composition in which the conjugated diene-based rubber polymer of step (a) is dissolved in a solvent.

A description of the conjugated diene-based monomer and a conjugated diene-based rubber polymer containing the same is as described above.

In step (a), a conjugated diene-based monomer may be polymerized in the presence of a catalyst to prepare high-cis 1,4-polybutadiene.

The catalyst may be a neodymium-based catalyst prepared from a monomolecular neodymium salt compound. As used herein, the term “monomolecular” refers to a compound prepared by coordination between a central metal element and a ligand. The monomolecular neodymium salt compound may be at least one selected from the group consisting of neodymium hexanoate, neodymium heptanoate, neodymium octanoate, neodymium octoate, neodymium naphthenate, neodymium stearate, neodymium versatate, neodymium bis(2-ethylhexyl)phosphate, neodymium bis(1-methylheptyl)phosphate, neodymium (mono-2-ethylhexyl-2-ethylhexyl)phosphonate), and neodymium bis(2-ethylhexyl) phosphite, but is not limited thereto.

The neodymium-based catalyst may be a catalyst system in which the neodymium salt compound, the conjugated diene-based monomer, the organoaluminum chloride compound, and the one or more organoaluminum compounds are each mixed in a predetermined molar ratio, for example, 1:5 to 30:1 to 5:10 to 60 and aged under certain conditions.

The catalyst may be a catalyst formed by mixing 5 to 30 moles, for example, 5 moles, 6 moles, 7 moles, 8 moles, 9 moles, 10 moles, 11 moles, 12 moles, 13 moles, 14 moles, 15 moles, 16 moles, 17 moles, 18 moles, 19 moles, 20 moles, 21 moles, 22 moles, 23 moles, 24 moles, 25 moles, 26 moles, 27 moles, 28 moles, 29 moles, 30 moles, or a range between two of these values of the conjugated diene monomer based on 1 mole of the monomolecular neodymium salt compound and aging the resulting mixture, but is not limited thereto.

The catalyst may be a catalyst formed by mixing 1 to 5 moles, for example, 1 mole, 2 moles, 3 moles, 4 moles, 5 moles, or a range between two of these values of the organoaluminum chloride compound based on 1 mole of the monomolecular neodymium salt compound and aging the resulting mixture, but is not limited thereto.

The catalyst may be a catalyst formed by mixing 10 to 60 moles, for example, 10 moles, 11 moles, 12 moles, 13 moles, 14 moles, 15 moles, 16 moles. 17 moles, 18 moles, 19 moles, 20 moles, 21 moles, 22 moles, 23 moles, 24 moles, 25 moles, 26 moles, 27 moles, 28 moles, 29 moles, 30 moles, 31 moles, 32 moles, 33 moles, 34 moles, 35 moles, 36 moles, 37 moles, 38 moles, 39 moles, 40 moles, 41 moles, 42 moles, 43 moles, 44 moles, 45 moles, 46 moles, 47 moles, 48 moles, 49 moles, 50 moles, 51 moles, 52 moles, 53 moles, 54 moles, 55 moles, 56 moles, 57 moles, 58 moles, 59 moles, 60 moles, or a range between two of these values of the one or more organoaluminum compounds based on 1 mole of the monomolecular neodymium salt compound and aging the resulting mixture, but is not limited thereto.

When a rubber polymer is prepared using such a neodymium-based catalyst, a high-cis rubber polymer having a high cis content may be prepared.

In addition, a molecular weight of the prepared rubber polymer may be controlled by adjusting a composition ratio of the catalyst. For example, a low molecular weight polymer may be prepared by relatively increasing a proportion of the organoaluminum compound or organoaluminoxane, but is not limited thereto.

In addition, the molecular weight of the polymer may be controlled by adjusting the ratio of the monomer and the solvent. When an amount of the solvent relative to the monomer is small, a high molecular weight polymer may be prepared, but is not limited thereto.

The catalyst may be a nickel-based catalyst prepared from a monomolecular nickel salt compound. The monomolecular nickel salt compound may be at least one selected from the group consisting of nickel hexanoate, nickel heptanoate, nickel octanoate, nickel 2-ethylhexanoate, nickel naphthenate, nickel versatate, nickel 1,2-cyclohexanediamino-N,N′-bis(3,5-t-butyl salicidine), nickel hexamethylacetylacetonate, and nickel stearate, but is not limited thereto.

The nickel-based catalyst may include a nickel salt compound, a conjugated diene-based monomer, an aluminum compound, and a boron fluoride complex compound. The nickel-based catalyst may be a catalyst system in which a nickel salt compound, an aluminum compound, and a boron fluoride complex compound are mixed at a predetermined molar ratio, for example, 1:1 to 20:0.7 to 50, and aged under certain conditions.

The aluminum compound may be at least one selected from the group consisting of trimethyl aluminum, triethyl aluminum, tripropyl aluminum, tributyl aluminum, triisobutyl aluminum, trihexyl aluminum, trioctyl aluminum, and diisobutyl aluminum hydride, but is limited thereto.

The boron fluoride complex compound may be a compound in which at least one selected from an ether compound, a ketone compound, and an ester compound is complexed with boron trifluoride (BF₃), but is not limited thereto. Examples of the ether compound include dimethyl ether, diethyl ether, dibutyl ether, tetrahydrofuran, dihexyl ether, dioctyl ether, and methyl t-butyl ether. Examples of the ketone compound include acetone, methyl ethyl ketone, cyclohexanone, methyl isoamyl ketone, and 2-heptanone. Examples of the ester compound include methyl acetylate, ethyl acetylate, butyl acetylate, methyl pyruvate, ethyl pyruvate, methyl methoxypropionate, and ethyl ethoxypropionate.

In addition, the nickel-based catalyst may be a catalyst system in which the nickel salt compound, the conjugated diene-based monomer, the organoaluminum chloride compound, and the one or more organoaluminum compounds are each mixed in a predetermined molar ratio, for example, 1:5 to 30:1 to 5:10 to 60 and aged under certain conditions.

The catalyst may be a catalyst formed by mixing 5 to 30 moles, for example, 5 moles, 6 moles, 7 moles, 8 moles, 9 moles, 10 moles, 11 moles, 12 moles, 13 moles, 14 moles, 15 moles, 16 moles, 17 moles, 18 moles, 19 moles, 20 moles, 21 moles, 22 moles, 23 moles, 24 moles, 25 moles, 26 moles, 27 moles, 28 moles, 29 moles, 30 moles, or a range between two of these values of the conjugated diene monomer based on 1 mole of the monomolecular nickel salt compound and aging the resulting mixture, but is not limited thereto.

The catalyst may be a catalyst formed by mixing 1 to 5 moles, for example, 1 mole, 2 moles, 3 moles, 4 moles, 5 moles, or a range between two of these values of the organoaluminum chloride compound based on 1 mole of the monomolecular nickel salt compound and aging the resulting mixture, but is not limited thereto.

The catalyst may be a catalyst formed by mixing 10 to 30 moles, for example, 10 moles, 11 moles, 12 moles, 13 moles, 14 moles, 15 moles, 16 moles, 17 moles, 18 moles, 19 moles, 20 moles, 21 moles, 22 moles, 23 moles, 24 moles, 25 moles, 26 moles, 27 moles, 28 moles, 29 moles, 30 moles, or a range between two of these values of the one or more organoaluminum compounds based on 1 mole of the monomolecular nickel salt compound and aging the resulting mixture, but is not limited thereto.

The aging of the catalyst may be pretreatment in a solvent at a temperature of −20° C. to 60° C. for 5 minutes to 2 hours, but is not limited thereto.

A reaction solvent for preparing the catalyst system is not particularly limited, and may be a non-polar solvent, an aliphatic hydrocarbon, a cycloaliphatic hydrocarbon, benzene, ethylbenzene, toluene, xylene, or the like that is not reactive with the catalyst, and for example, may be at least one selected from the group consisting of pentane, hexane, isopentane, heptane, octane, isooctane, cyclopentane, methylcyclopentane, cyclohexane, methylcyclohexane, and ethylcyclohexane.

The organoaluminum chloride compound may be at least one selected from the group consisting of diethyl aluminum chloride, dimethyl aluminum chloride, dipropyl aluminum chloride, diisobutyl aluminum chloride, dihexyl aluminum chloride, dioctyl aluminum chloride, ethyl aluminum dichloride, methyl aluminum dichloride, propyl aluminum dichloride, isobutyl aluminum dichloride, hexyl aluminum dichloride, octyl aluminum dichloride, ethyl aluminum sesquichloride, methyl aluminum sesquichloride, propyl aluminum sesquichloride, isobutyl aluminum sesquichloride, hexyl aluminum sesquichloride, and octyl aluminum sesquichloride, but is not limited thereto.

The organoaluminum compound or organoaluminoxane may be at least one selected from the group consisting of trimethylaluminum, triethylaluminum, tripropylaluminum, tributylaluminum, triisobutylaluminum, trihexylaluminum, trioctylaluminum, diisobutylaluminum hydride, dimethylaluminum hydride, diethyl aluminum hydride, dipropyl aluminum hydride, dibutyl aluminum hydride, diisobutyl aluminum hydride, dihexyl aluminum hydride, dioctyl aluminum hydride, methyl aluminoxane (MAO), modified methyl aluminoxane (MMAO), ethyl aluminoxane, propyl aluminoxane, isobutyl aluminoxane, isobutyl aluminoxane, hexyl aluminoxane, and octyl aluminoxane, but is not limited thereto.

Step (b) may be a step of dissolving the conjugated diene-based rubber polymer prepared in step (a) in a solvent suitable for a battery slurry composition after separating the polymer from the reaction system.

After completion of a polymerization reaction in step (a), the conjugated diene-based rubber polymer may be removed from a reaction solvent using a method such as aggregation or drying to obtain a solid rubber. A binder composition for an all-solid-state battery may be prepared by dissolving the separated conjugated diene-based rubber polymer in the solvent.

When the same solvent used in the binder composition is used as a reaction solvent used during polymerization, a separate separation and dissolution step may not be included, but even in this case, impurities such as catalysts need to be removed.

Slurry Composition for all-Solid-State Battery and all-Solid-State Battery

The slurry composition for an all-solid-state battery may include the above-described binder composition; and at least one selected from the group consisting of a conductive material, a positive electrode active material, a negative electrode active material, and a solid electrolyte.

The binder composition for an all-solid-state battery may be used in at least one layer of a positive electrode active material layer, a negative electrode active material layer, and a solid electrolyte layer. The positive electrode active material layer may be applied on an aluminum current collector to form a positive electrode. The negative electrode active material layer may be applied on a copper current collector to form a negative electrode. The solid electrolyte layer may be interposed between the positive electrode active material layer and the negative electrode active material layer to block direct contact between the positive electrode and the negative electrode and transfer metal ions.

The positive electrode active material layer or the negative electrode active material layer may be formed by applying the electrode slurry composition for an all-solid-state battery including the binder composition; the conductive material; and the positive electrode active material or the negative electrode active material described above, and then drying a solvent

The type of conductive material is not particularly limited as long as it has conductivity without causing a chemical change in the battery. For example, the conductive material may be graphite such as natural graphite or artificial graphite; carbon black such as carbon black, acetylene black, ketjen black, channel black, furnace black, lamp black, and thermal black; conductive fibers such as carbon fibers and metal fibers; metal powders such as carbon fluoride, aluminum, and nickel powders; conductive whiskers such as zinc oxide and potassium titanate; conductive metal oxides such as titanium oxide; a conductive material such as a polyphenylene derivative; or a highly functional nano-carbon such as carbon nanotubes or graphene, but is not limited thereto. A content of the conductive material may be 1 to 15 parts by weight based on 100 parts by weight of the slurry composition. For example, the content may be 1 part by weight, 2 parts by weight, 3 parts by weight, 4 parts by weight, 5 parts by weight, 6 parts by weight, 7 parts by weight, 8 parts by weight, 9 parts by weight, 10 parts by weight, 11 parts by weight, 12 parts by weight part, 13 parts by weight, 14 parts by weight, 15 parts by weight, or a range between two of these values.

The positive electrode active material may be oxide of lithium and a metal. For example, the positive electrode active material includes NCM positive electrode materials containing nickel, cobalt, and manganese, NCA positive electrode materials containing nickel, cobalt, and aluminum, LCO positive electrode materials containing cobalt, LMO positive electrode materials containing manganese, LFP positive electrode materials containing phosphoric acid and iron, and the like.

The type of negative electrode active material is not limited as long as it is a material capable of storing metal during charging, such as graphite, silicon, silica, tin, and tin oxide. Although a silica negative electrode material is known to have a volume change of about 400% during charging and discharging, making it difficult to maintain long-term capacity, when the binder composition is used, adhesive strength and elasticity are excellent, and thus it can be improved.

The solid electrolyte layer may be formed by applying the slurry composition for an all-solid-state battery including the binder composition; and the solid electrolyte described above, and then drying a solvent.

A solid content of the binder composition may be 0.5 to 10 parts by weight based on 100 parts by weight of the slurry composition. For example, the solid content may be 0.5 parts by weight, 0.6 parts by weight, 0.7 parts by weight, 0.8 parts by weight, 0.9 parts by weight, 1 part by weight, 2 parts by weight, 3 parts by weight, 4 parts by weight, 5 parts by weight, 6 parts by weight, 7 parts by weight, 8 parts by weight, 9 parts by weight, 10 parts by weight, or a range between two of these values.

The solid electrolyte may be at least one of a sulfide-based electrolyte, an oxide-based electrolyte, and a polymer-based electrolyte. The sulfide-based electrolyte may be, for example, LGPS, LPS, LPSCl, LSS, or LSGM, but is not limited thereto. The oxide-based electrolyte may be, for example, LiPON, LLZO, LLTO, NASICON, LAGP, or LATP, but is not limited thereto. The polymer-based electrolyte may refer to, for example, an electrolyte solution or an electrolyte filled in a polymer matrix such as PVdF or PEO. In one example, the solid electrolyte may be a composite electrolyte of two or more of the above-mentioned electrolytes.

A content of the solid electrolyte may be 5 to 30 parts by weight based on 100 parts by weight of the slurry composition. For example, the content may be 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, 30 parts by weight, or a range between two of these values.

The solid concentration of the slurry composition may be 20 to 50% by weight. For example, the solid concentration may be 20% by weight, 21% by weight, 22% by weight, 23% by weight, 24% by weight, 25% by weight, 26% by weight, 27% by weight, 28% by weight, 29% by weight, 30% by weight, 31% by weight, 32% by weight, 33% by weight, 34% by weight, 35% by weight, 36% by weight, 37% by weight, 38% by weight, 39% by weight, 40% by weight, 41% by weight, 42% by weight, 43% by weight, 44% by weight, 45% by weight, 46% by weight, 47% by weight, 48% by weight, 49% by weight, 50% by weight, or a range between two of these values. When the solid concentration is outside the above range, application may be difficult or physical properties of the battery may be deteriorated.

The solid concentration may be adjusted by adding a solvent. The type of solvent is not particularly limited as long as it does not have reactivity with other components, but since the sulfide-based solid electrolyte has reactivity with polar solvents, side reactions may occur when a polar solvent is introduced. The solvent may be at least one selected from the group consisting of benzene, toluene, xylene, hexane, cyclohexane, methylcyclohexane, ethylcyclohexane, nonane, decane, decalin, tetralin, dodecane, dibromomethane, dichloromethane, chloroform, butyl butyrate, and hexyl butyrate.

An all-solid-state battery according to one aspect of the present specification includes a positive electrode; a negative electrode; and a solid electrolyte, and at least one of the positive electrode, the negative electrode, and the solid electrolyte may be prepared by applying the slurry composition including the binder composition described above and drying the solvent.

Hereinafter, examples of the present specification will be described in more detail. However, the following experimental results describe only representative experimental results among the examples, and the scope and content of the present specification may not be construed as reduced or limited by the examples. Each effect of the various embodiments of the present specification not explicitly presented below will be specifically described in the corresponding section.

### Comparative Preparation Example 1

An acrylonitrile butadiene rubber containing 34% by weight of acrylonitrile was set as a comparative example.

### Comparative Preparation Example 2

A styrene-butadiene rubber having a styrene content of 21% by weight and a cis content of 17% was set as a comparative example.

### Preparation Example 1

NdBR40 (Kumho Petrochemical), which is an NdBR-based rubber material, was set as Preparation Example 1.

### Preparation Example 2

NdBR60 (Kumho Petrochemical), which is an NdBR-based rubber material, was set as Preparation Example 2.

### Preparation Example 3

KBR01 (Kumho Petrochemical), which is an NiBR-based rubber material, was set as Preparation Example 3.

### Preparation Example 4

A catalyst was prepared by mixing a monomolecular neodymium versatate (1.2 mmol) solution with 1,3-butadiene (15.6 mmol) and then adding diisobutylaluminum hydride (17.2 mmol), triisobutylaluminum (9.0 mmol), and diisobutyl chloride aluminum (2.6 mmol). At this time, a content of neodymium in the monomolecular neodymium versatate was 1.5×10⁻⁴ moles per 100 g of monomers. After sufficiently blowing nitrogen, neodymium versatate, 1,3-butadiene, diisobutylaluminum hydride, triisobutylaluminum, and diisobutylaluminum chloride were sequentially added to a 100 mL round flask sealed with a rubber stopper, and then a reaction catalyst was aged at 20° C. for a certain period of time and used.

A polymerization reaction was performed by sufficiently blowing nitrogen into a 5 L pressure glass reactor and then adding a cyclohexane polymerization solvent in an amount that was 5 times the content of monomers. After the catalyst was transferred and added under nitrogen charging, butadiene (400 g) as a monomer was added and polymerization was performed at 70° C. for 2 hours. After the polymerization reaction, a reaction terminator and an antioxidant were added to terminate the reaction to obtain high-cis 1,4-polybutadiene.

### Preparation Example 5

After mixing monomolecular nickel naphthenate (0.5 mmol) and 1,3-butadiene (0.7 mmol), boron trifluoride ethyl ether (5.1 mmol) and triethyl aluminum (3.0 mmol) were added to prepare a catalyst. At this time, a content of nickel in the monomolecular nickel naphthenate was 5.5×10⁻⁵ moles per 100 g of monomers. After sufficiently blowing nitrogen, nickel naphthenate, boron trifluoride ethyl ether, and triethyl aluminum were sequentially added to a 100 mL round flask sealed with a rubber stopper, and then a reaction catalyst was aged at 20° C. for a certain period of time and used. A polymerization reaction was performed by sufficiently blowing nitrogen into a 5 L pressure glass reactor and then adding a cyclohexane polymerization solvent in an amount that was 5 times the content of monomers. After the catalyst was transferred and added under nitrogen charging, butadiene (400 g) as a monomer was added and polymerization was performed at 70° C. for 2 hours. After the polymerization reaction, a reaction terminator and an antioxidant were added to terminate the reaction to obtain high-cis 1,4-polybutadiene.

### Preparation Example 6

A catalyst was prepared by mixing a monomolecular neodymium versatate (1.2 mmol) solution with 1,3-butadiene (15.6 mmol) and then adding diisobutylaluminum hydride (17.2 mmol), triisobutylaluminum (9.0 mmol), and diisobutyl chloride aluminum (2.6 mmol). At this time, a content of neodymium in the monomolecular neodymium versatate was 1.5×10⁻⁴ moles per 100 g of monomers. After sufficiently blowing nitrogen, neodymium versatate, 1,3-butadiene, diisobutylaluminum hydride, triisobutylaluminum, and diisobutylaluminum chloride were sequentially added to a 100 mL round flask sealed with a rubber stopper, and then a reaction catalyst was aged at 20° C. for a certain period of time and used.

A polymerization reaction was performed by sufficiently blowing nitrogen into a 5 L pressure glass reactor and then adding a cyclohexane polymerization solvent in an amount that was 5 times the content of monomers. After the catalyst was transferred and added under nitrogen charging, butadiene (600 g) as a monomer was added and polymerization was performed at 70° C. for 2 hours. After the polymerization reaction, a reaction terminator and an antioxidant were added to terminate the reaction to obtain high-cis 1,4-polybutadiene.

### Experimental Example 1

The characteristics of 1,4-polybutadiene prepared according to the Comparative Preparation Examples and Preparation Examples 1 to 6 were analyzed and shown in Table 1 below.

Each analysis method is as follows.

1) Measurement of Molecular Weight

A molecular weight was measured through gel permeation chromatography (GPC) using a tetrahydrofuran (THF) solvent and a crosslinked polystyrene-divinylbenzene standard material.

2) Measurement of Solution Viscosity

The solidified and dried sample was dissolved in toluene to a concentration of 5.23% by weight, and a viscosity at 25° C. (cps@25° C.) was measured using an automatic viscosity measurement device.

3) Measurement of Mooney Viscosity

30 g of each solid rubber was taken, and two specimens having a thickness of 0.8 cm and an area of 5 cm×5 cm were prepared using a roller. The specimen was attached to the front and back of a rotor and mounted on a rotational viscometer (ALPHA Technologies, MOONEY MV2000). The specimen was preheated to 100° C. for the first minute, and the rotor was started to measure the viscosity change of the solid rubber for 4 minutes to obtain Mooney viscosity expressed as a value of ML1+4 (100° C.).

4) Measurement of Cis Content

In order to confirm the microstructure of the solid rubber, each content was measured by the Morero method. After completely dissolving 40 mg of the solid rubber sample in 5 mL of CS₂, a rubber liquid was placed in a KBr cell at 1 mm intervals and measured using an infrared spectrometer (FTS-60A, BIO-RAD Co.). At this time, infrared peaks to be measured are cis absorbance (AC) at 739 cm⁻¹, vinyl absorbance (AV) at 912 cm⁻¹, and trans absorbance (AT) at 966 cm⁻¹. A content of each microstructure was calculated from the measured absorbance using the following Equation.

$$C = ( 1.7455 \times AC - 0.0151 \times AV ) \\ V = ( 0.3746 \times AV - 0.007 \times AC ) \\ T = ( 0.4292 \times AT - 0.0129 \times AV - 0.0454 \times AC ) \\ ( Cis , \% ) = \frac{C}{C + V + T} \times 100 \\ ( Trans , \% ) = \frac{T}{C + V + T} \times 100 \\ ( Vinyl , \% ) = \frac{V}{C + V + T} \times 100 \qquad < E q u a t i o n >$$

TABLE 1

| | | | | | | | AN(%) or |
|---|---|---|---|---|---|---|---|
| | GPC | | | Mooney | Solution | Branching | ST(%), |
| | | | MW | Viscosity | Viscosity | degree | Cis/Trans/ |
| Classification | Mn | Mw | D | (MV) | (SV) | (MV/SV*10) | Vinyl (%) |
| Comparative | 121,000 | 415,000 | 3.42 | 41 | NA | NA | 34%, NA |
| Preparation | | | | | | | |
| Example 1 | | | | | | | |
| Comparative | 295,000 | 604,000 | 2.05 | 63 | NA | NA | 21%, |
| Preparation | | | | | | | 17.2%/19.8%/ |
| Example 2 | | | | | | | 63.0% |
| Preparation | 243,000 | 645,000 | 2.77 | 43 | 216 | 2.0 | 0%, |
| Example 1 | | | | | | | 96.9/2.0/1.1 |
| Preparation | 279,000 | 772,000 | 2.65 | 63 | 403 | 1.6 | 0%, |
| Example 2 | | | | | | | 97.2/1.8/1.0 |
| Preparation | 156,000 | 615,000 | 3.94 | 43 | 113 | 3.8 | 0%, |
| Example 3 | | | | | | | 96.0/2.5/1.5 |
| Preparation | 308,000 | 678,000 | 2.20 | 57 | 338 | 1.7 | 0%, |
| Example 4 | | | | | | | 97.3/1.8/1.0 |
| Preparation | 153,000 | 635,000 | 4.15 | 44 | 110 | 4.0 | 0%, |
| Example 5 | | | | | | | 95.5/2.7/1.8 |
| Preparation | 318,000 | 737,000 | 2.32 | 61 | 386 | 1.6 | 0%, |
| Example 6 | | | | | | | 97.1/2.0/0.8 |

Referring to Table 1, it can be confirmed that all of the high-cis 1,4-polybutadienes of Preparation Examples 1 to 6 have 96% by weight or more of cis bonds, and accordingly, it can be predicted that the adhesive performance of the binder composition will be improved. Among the Preparation Examples prepared under a neodymium-based catalyst, Preparation Examples 2, 4, and 6, except for Preparation Example 1, showed an increase in Mooney viscosity.

### Examples 1 to 6 and Comparative Example

A binder composition was prepared by mixing 5% by weight of each rubber polymer of Preparation Examples 1 to 6 and Comparative Preparation Example and 95% by weight of xylene.

2 parts by weight of a binder composition was mixed with 100 parts by weight of sulfide glass (average particle diameter: 1.2 μm, cumulative particle diameter of 90%: 2.1 μm) containing 70 mol % and 30 mol % of Li₂S and P₂S₅, respectively, as a solid electrolyte, and xylene was added to adjust a solid concentration to 30% by weight. Then, a slurry composition for forming a solid electrolyte layer was prepared by mixing using a planetary mixer. In the following Experimental Example 2, materials other than the binder composition, the solid electrolyte, and the solvent were not added to evaluate physical properties of the binder composition.

### Experimental Example 2

The characteristics of a binder composition and a slurry composition prepared according to each of the Comparative Example and Examples 1 to 6 were analyzed and shown in Table 2 below.

Each analysis method is as follows.

Evaluation of Solvent Solubility

To evaluate the solvent solubility of rubber polymer, a binder composition was prepared by adding 5% by weight of each rubber polymer of Preparation Examples 1 to 6 and Comparative Preparation Example to 95% by weight of each of xylene and butyl butyrate as solvents to evaluate whether the rubber polymer was dissolved in the solvent.

Measurement of Film Adhesive Strength

2 to 3 g of the binder composition prepared according to each of the Comparative Example and Examples was placed between polyester films, and pressed at 90° C. for 3 minutes using pressing equipment. After manufacturing a specimen in a dog-bone shape according to specimen standard ASTM D638, the specimen was measured using peeling test equipment (UTM for SHIMADZU thin film measurement). The peeling test was performed under conditions of a test speed of 100 mm/min and a stroke of 60 mm in a 180-degree peel test.

Measurement of Electrode Adhesive Strength

2 to 3 g of the binder composition prepared according to each of the Comparative Example and Examples was placed between a positive electrode and a negative electrode, and pressed at 90° C. for 3 minutes using pressing equipment. After manufacturing a specimen in a dog-bone shape according to specimen standard ASTM D638, the specimen was measured using peeling test equipment (UTM for SHIMADZU thin film measurement). The peeling test was performed under conditions of a test speed of 100 mm/min and a stroke of 60 mm in a 180-degree peel test. A value of Example 1 was set to 1, and values of Examples 2 to 6 and Comparative Example were expressed as relative values.

Measurement of Interfacial Resistance

A slurry composition for a solid electrolyte layer prepared according to each of the Comparative Example and Examples was applied onto one side of an aluminum foil having a thickness of 14 μm using a coater with a gap of 200 μm, and dried on a hot plate at 80° C. to form a solid electrolyte layer. An aluminum foil having the same thickness of 14 μm was laminated on a surface of the solid electrolyte layer to form a test piece in which the solid electrolyte layer was sandwiched between two pieces of aluminum foil. After the test piece was punched out with a metal punch having a diameter of 10 mm, the test piece was compacted with a pressing machine at a pressure of 2 MPa. A resistance value of the compacted solid electrolyte layer was measured using an impedance meter, and the resistance value was calculated from the Nyquist plot.

Processability Evaluation

A slurry composition for a solid electrolyte layer prepared according to each of the Comparative Example and Examples was applied onto one side of an aluminum foil having a thickness of 14 μm using a coater with a gap of 200 μm, and dried on a hot plate at 80° C. to form a solid electrolyte layer. In order to evaluate processability, a surface of an exterior sheet and contamination of the surface were visually observed and evaluated.

TABLE 2

| | | | Electrode | | | | |
|---|---|---|---|---|---|---|---|
| | | | adhesive | Film | | Processability | |
| | Solvent solubility | | strength | adhesive | Interfacial | Exterior | |
| | | Butyl | (relative | strength | resistance | sheet | |
| Classification | Xylene | butyrate | value) | (mN) | (Ω) | surface | Contamination |
| Comparative | ◯ | X | 0.3 | 130 | 11.8 | X | Δ |
| Example 1 | | | | | | | |
| Example 1 | ◯ | ◯ | 1.0 | 222 | 3.2 | ◯ | ◯ |
| Example 2 | ◯ | ◯ | 4.0 | 240 | 4.5 | ◯ | ◯ |
| Example 3 | ◯ | ◯ | 4.5 | 178 | 3.7 | ◯ | ◯ |
| Example 4 | ◯ | ◯ | 8.0 | 245 | 5.5 | ◯ | ◯ |
| Example 5 | ◯ | ◯ | 4.8 | 217 | 4.8 | ◯ | ◯ |
| Example 6 | ◯ | ◯ | 7.5 | 238 | 3.3 | ◯ | ◯ |

Referring to Table 2, the rubber polymer of Comparative Preparation Example 1 showed poor solvent solubility in butyl butyrate. In contrast, it was confirmed that the rubber polymers of Preparation Examples 1 to 6 were completely dissolved in both solvents, and the electrode adhesive strength and film adhesive strength of the binder compositions of Examples 1 to 6 were excellent. In addition, it can be confirmed that all of the slurry compositions of Examples 1 to 6 had an interfacial resistance of 6Ω or less, indicating that battery performance was improved. It can be confirmed that the processability of the slurry compositions of Examples 1 to 6 was improved by showing an excellent exterior sheet surface and excellent contamination, which were evaluated visually. In contrast, it can be confirmed that the slurry composition of Comparative Example 1 has increased interfacial resistance and deteriorated processability compared to those of the Examples.

Evaluation of Discharge Capacity

A positive electrode slurry in which a positive electrode active material, a conductive material, a binder, and a solvent were dispersed was applied on one side of an aluminum foil and then dried to manufacture a positive electrode. A slurry composition for a solid electrolyte layer prepared according to each of the Comparative Examples and Examples was applied onto a surface of a positive electrode using a coater with a gap of 200 μm, and dried on a hot plate at 80° C. to form a solid electrolyte layer. A CR2032 type half-cell was manufactured using a lithium foil as a negative electrode.

The discharge capacity and initial charge efficiency (I.C.E) were measured by repeating charging and discharging 30 times under conditions of 3.0 to 4.3 V and 100 mA/g at room temperature, and the results are shown in Table 3 below.

TABLE 3

| | | Right after | 1st | 15th | 30th |
|---|---|---|---|---|---|
| Classification | I.C.E (%) | manufacture | discharge | discharge | discharge |
| Comparative | 83 | 173 | 162 | 140 | 131 |
| Example 1 | | | | | |
| Comparative | 77 | 157 | 125 | 130 | 121 |
| Example 2 | | | | | |
| Example 1 | 89 | 213 | 200 | 192 | 185 |
| Example 2 | 88 | 221 | 205 | 189 | 175 |
| Example 3 | 82 | 182 | 175 | 158 | 147 |
| Example 4 | 85 | 208 | 196 | 182 | 176 |
| Example 5 | 85 | 205 | 194 | 179 | 165 |
| Example 6 | 85 | 187 | 175 | 159 | 150 |

Referring to Table 3, the Examples using the rubber polymers of the Preparation Examples as a binder had higher discharge capacity and better rate capability than the Comparative Examples using the rubber polymers of the Comparative Preparation Examples as a binder.

In particular, Examples 1, 2, 4, and 6 using an NdBR-based rubber polymer had better electrochemical properties than Examples 3 and 5 using an NiBR-based rubber polymer, which is expected to be due to high linearity and viscoelastic properties.

According to one aspect, a binder for an all-solid-state battery having excellent bonding strength between components of the all-solid-state battery and excellent usability with a solid electrolyte is provided.

The effect of one aspect of the present specification is not limited to the above effect, and it should be understood to include all effects that can be inferred from the configuration described in the detailed description or claims of the present specification.

The description of the present specification described above is for illustration, and it should be understood that those of ordinary skill in the art to which one aspect of the present specification belongs can easily modify it into other specific forms without changing the technical idea or essential features described in this specification. Therefore, it should be understood that the embodiments described above are illustrative in all respects and not restrictive. For example, each component described as a single type may be implemented in a distributed form, and likewise components described as distributed may be implemented in a combined form.

The scope of the present specification is indicated by the following claims, and all changes or modifications derived from the meaning and scope of the claims and their equivalents should be construed as being included in the scope of the present specification.

What is claimed is:

1. A binder composition for an all-solid-state battery, comprising a conjugated diene-based rubber polymer and a solvent,
wherein a content of a cis bond in the conjugated diene-based rubber polymer is 90% by weight or more.

2. The binder composition of claim 1, wherein the conjugated diene-based rubber polymer is a polymer of at least one monomer selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo 1,3-hexadiene.

3. The binder composition of claim 1, wherein a cis content of the conjugated diene-based rubber polymer is 95% by weight or more.

4. The binder composition of claim 1, wherein the conjugated diene-based rubber polymer is produced using a neodymium-based catalyst or a nickel-based catalyst.

5. The binder composition of claim 4, wherein the neodymium-based catalyst includes a neodymium salt compound, a conjugated diene-based monomer, an organoaluminum chloride compound, and one or more organoaluminum compounds.

6. The binder composition of claim 4, wherein the nickel-based catalyst includes a nickel salt compound, a conjugated diene-based monomer, an aluminum compound, and a boron fluoride complex compound.

7. The binder composition of claim 1, wherein the conjugated diene-based rubber polymer has a weight average molecular weight of 100,000 to 2,000,000.

8. The binder composition of claim 1, wherein the conjugated diene-based rubber polymer has a solution viscosity of 80 to 1,200 cps at 25° C.

9. The binder composition of claim 1, wherein the conjugated diene-based rubber polymer has a Mooney viscosity of 30 to 100.

10. The binder composition of claim 1, wherein the conjugated diene-based rubber polymer has a branching degree of 0.8 to 4.

11. The binder composition of claim 1, wherein the solvent is at least one selected from the group consisting of benzene, toluene, xylene, hexane, cyclohexane, methylcyclohexane, ethylcyclohexane, nonane, decane, decalin, tetralin, dodecane, dibromomethane, dichloromethane, chloroform, butyl butyrate, and hexyl butyrate.

12. The binder composition of claim 1, wherein a content of the conjugated diene-based rubber polymer is 0.5 to 40% by weight based on a total weight of the binder composition.

13. The binder composition of claim 1, wherein the conjugated diene-based rubber polymer is dissolved in a butyl butyrate solvent at room temperature.

14. A slurry composition for an all-solid-state battery, comprising:
the binder composition of claim 1; and
at least one selected from the group consisting of a conductive material, a positive electrode active material, a negative electrode active material, and a solid electrolyte.

15. An all-solid-state battery, comprising:
a positive electrode;
a negative electrode; and
a solid electrolyte,
wherein at least one of the positive electrode, the negative electrode, and the solid electrolyte is prepared by applying a slurry composition containing the binder composition of claim 1, and drying a solvent.
